(19) United States
(12) Patent Application Publication
(10) Pub. No.: US 2022/0122341 A1
(43) Pub. Date: Apr. 21, 2022

(54) TARGET DETECTION METHOD AND APPARATUS, ELECTRONIC DEVICE, AND COMPUTER STORAGE MEDIUM

(71) Applicant: Sensetime International PTE.Ltd., Singapore (SG)

(72) Inventor: Chunya Liu, Singapore (SG)

(21) Appl. No.: 17/562,226

(22) Filed: Dec. 27, 2021

Related U.S. Application Data
(63) Continuation of application No. PCT/IB2021/062081, filed on Dec. 21, 2021.

(30) Foreign Application Priority Data
Dec. 17, 2021 (SG) 10202114024R

(51) Int. Cl. G06V 10/26; G06V 10/82; G06V 10/75; G06V 20/52

(52) U.S. Cl. CPC G06V 10/267; G06V 10/82; G06V 2201/07; G06V 20/52; G06V 10/75

(57) ABSTRACT

Provided are a target detection method and apparatus, an electronic device, and a computer storage medium. The method includes that: a first detection result of a game platform image is determined, the game platform image being obtained by performing resolution reducing processing on the original game platform image, and the first detection result being used for characterizing a region where a target object is located; the region where the target object is located is expanded outward in the original game platform image to obtain the clipping region, and the original game platform image is clipped to obtain the clipped image according to the clipping region; and the first detection result is optimized to obtain the second detection result according to the clipped image.

### CROSS-REFERENCE TO RELATED APPLICATION(S)

The application is continuation of international patent application No. PCT/IB2021/062081, filed on 21 Dec. 2021, which claims priority to Singaporean patent application No. 10202114024R, filed with IPOS on 17 Dec. 2021. The contents of international patent application PCT/IB2021/062081 and Singaporean patent application No. 10202114024R are incorporated herein by reference in their entireties.

### TECHNICAL FIELD

The disclosure relates to a computer vision processing technology, and relates, but not limited, to a target detection method and apparatus, an electronic device, and a computer storage medium.

### BACKGROUND

Target detection is widely applied to intelligent video analysis systems. In a game platform scenario, the detection of an object related to a game platform helps to analyze images of the game platform scenario. In the related art, since the resolution of the images for target detection is low, the accuracy of the target detection is low.

### SUMMARY

The embodiments of the disclosure may provide a target detection method and apparatus, an electronic device, and a computer storage medium, which can accurately obtain a detection result of a target object.

The embodiments of the disclosure provide a target detection method. The method may include the following operations.

A first detection result of a game platform image may be determined, the game platform image may be obtained by performing resolution reducing processing on an original game platform image, and the first detection result may be used for characterizing a region where the target object is located.

The region where the target object is located is expanded outward in the original game platform image to obtain a clipping region, and the original game platform image is clipped to obtain a clipped image according to the clipping region.

The first detection result is optimized to obtain a second detection result according to the clipped image.

In some embodiments, the operation that the first detection result is optimized to obtain a second detection result according to the clipped image may include the following operations.

An image feature of the clipped image is extracted.

A feature of the target object in the clipped image is determined according to the first detection result and the image feature.

The second detection result is obtained according to the feature of the target object.

In some embodiments, the operation that the image feature of the clipped image is extracted may include the following operation.

The image feature of the clipped image is extracted by using a residual network.

In some embodiments, the operation that a feature of the target object in the clipped image is determined according to the first detection result and the image feature may include the following operations.

The first detection result and the image feature are input into a regression model, and the first detection result and the image feature are processed by using the regression model to obtain the feature of the target object in the clipped image.

The operation that the second detection result is obtained according to the feature of the target object may include the following operation.

The feature of the target object is processed to obtain the second detection result by using the regression model.

In some embodiments, the regression model is a fully connected network.

In some embodiments, a training method for the regression model includes the following steps.

An image feature of a partial image in a first sample image, a third detection result of a second sample image, and annotation information of the first sample image are acquired. The second sample image is obtained by performing resolution reducing processing on the first sample image. The third detection result is used for characterizing a region where a reference object is located. A region of the partial image includes the region where the reference object is located.

The image feature of the partial image and the third detection result are input into the regression model. The image feature of the partial image and the third detection result are processed by using the regression model to obtain a fourth detection result. The fourth detection result represents an optimized result of the third detection result.

A network parameter value of the regression model is adjusted according to the fourth detection result and the annotation information of the first sample image.

In some embodiments, the region where the target object is located is a detection box.

The operation that the region where the target object is located is expanded outward in the original game platform image to obtain a clipping region may include the following operation.

The detection box is expanded in at least one of an upward direction, a downward direction, a leftward direction, or a rightward direction in the original game platform image to obtain the clipping region.

The embodiments of the disclosure further provide a target detection apparatus. The apparatus includes: a determination module, a first processing module, and a second processing module.

The determination module is configured to determine a first detection result of a game platform image, the game platform image is obtained by performing resolution reducing processing on an original game platform image, and the first detection result is used for characterizing a region where the target object is located.

The first processing module is configured to expand the region where the target object is located outward in the original game platform image to obtain a clipping region, and clip the original game platform image to obtain a clipped image according to the clipping region.

The second processing module is configured to optimize the first detection result to obtain a second detection result according to the clipped image.

The embodiments of the disclosure further provide an electronic device, including a processor and a memory configured to store a computer program capable of running on the processor.

The processor is configured to run the computer program to execute any one of the above target detection methods.

The embodiments of the disclosure further provide a computer storage medium, which stores a computer program. Any one of the above target detection methods is implemented when the computer program is executed by a processor.

According to the target detection method and apparatus, the electronic device, and the computer storage medium provided by the embodiments of the disclosure, the first detection result of the game platform image is determined, the game platform image is obtained by performing resolution reducing processing on the original game platform image, and the first detection result is used for characterizing the region where the target object is located. The region where the target object is located is expanded outward in the original game platform image to obtain the clipping region, and the original game platform image is clipped to obtain the clipped image according to the clipping region. The first detection result is optimized to obtain the second detection result according to the clipped image.

It can be seen that the clipping region is greater than the region where the target object is located, and the resolution of the original game platform image is higher than that of the game platform image, the clipped image can reflect fine local information of the target object, and then the first detection result is optimized according to the clipped image, which is beneficial to obtaining the region where the target object is located more accurately, and improves the accuracy of target detection.

It is to be understood that the above general description and the following detailed description are only exemplary and explanatory and not intended to limit the disclosure.

### BRIEF DESCRIPTION OF THE DRAWINGS

The drawings here are incorporated in the specification as a part of the specification. These drawings show embodiments that are in accordance with the disclosure, and used together with the specification to describe the disclosure.

FIG. 1 is a flowchart of a target detection method of the embodiments of the disclosure.

FIG. 2 is a schematic diagram of performing target detection on a game platform image by using a Faster-Regions with Convolutional Neural Network (Faster-RCNN) framework in the embodiments of the disclosure.

FIG. 3 is another flowchart of a target detection method of the embodiments of the disclosure.

FIG. 4 is yet another flowchart of a target detection method of the embodiments of the disclosure.

FIG. 5 is a flowchart of a training method for a regression model of the embodiments of the disclosure.

FIG. 6 is a structural schematic diagram of a target detection apparatus of the embodiments of the disclosure.

FIG. 7 is a structural schematic diagram of an electronic device of the embodiments of the disclosure.

### DETAILED DESCRIPTION

In a game platform scenario, a ten-million-pixel camera may be configured to collect images. However, in a related art, the images collected by the ten-million-pixel camera cannot be directly applied to training and application of a target detection model, because: excessive consumption of the resources, such as a video card memory, is easily caused if the target detection model is trained by directly using a high-resolution image or the high-resolution image is processed by using the trained target detection model. Therefore, the images collected by the ten-million-pixel camera may be subjected to resolution reducing processing to zoom out a ten-million-pixel image into a million-pixel image, and then the million-pixel image is applied to the training and application of the target detection model. Illustratively, the thickness of a target object in the ten-million-pixel image is about 8 pixels, and then the thickness of the target object in the million-pixel image is only about 1 to 2 pixels. Since there are few target features, the accuracy of target detection is low, that is, the position of a target detection box is prone to bias. If the positions of a stack of targets are determined by directly using the target detection frame with low accuracy, false detection (including repeated detection and missing detection) are easily caused, which does not meet the accuracy requirement of the target object detection in the game platform scenario.

The disclosure is further described below in detail with reference to accompanying drawings and embodiments. It is to be understood that the embodiments provided herein are only adopted to explain the disclosure and not intended to limit the disclosure. In addition, the embodiments provided below are not all embodiments implementing the disclosure but part of embodiments implementing the disclosure, and the embodiments of the disclosure may be freely combined for implementation without conflicts.

It is to be noted that, in the embodiments of the disclosure, terms “include” and “contain” or any Others variant thereof is intended to cover nonexclusive inclusions herein, so that method or device including a series of elements not only includes those clearly recorded elements but also includes other elements which are not clearly listed or further includes intrinsic elements for implementing the method or the device. Under the condition of no more limitations, an element defined by a statement “including a/an . . . ” does not exclude existence of another related element in a method or device including the element (for example, step in the method or a unit in the apparatus, the unit may be, for example, part of a circuit, part of a processor and part of a program or software).

For example, a target detection method provided by the embodiments of the disclosure includes a series of steps, but the target detection method provided by the embodiments of the disclosure is not limited to the recorded steps. Similarly, a target detection apparatus provided by the embodiments of the disclosure includes a series of modules, but the apparatus provided by the embodiments of the disclosure is not limited to include the clearly recorded modules, and may further include a module required to be arranged when related information is acquired or processing is performed on the basis of information.

The term “and/or” in this specification describes only an association relationship for describing associated objects and represents that three relationships may exist. For example, A and/or B may represent the following three cases: Only A exists, both A and B exist, and only B exists. In addition, term “at least one” in the disclosure represents any one of multiple or any combination of at least two of multiple. For example, including at least one of A, B, or C may represent including any one or more elements selected from a set formed by A, B, or C.

The embodiments of the disclosure may be applied to an edge computing device or a server device in a game platform scenario, and may be operated together with numerous other universal or dedicated computing system environments or configurations. Here, the edge computing device may be a thin client, a thick client, a hand-held or laptop device, a microprocessor-based system, a set-top box, a programmable consumer electronic product, a network personal computer, a minicomputer system, etc. The server device may be a minicomputer system, a large computer system, distributed cloud computing technology environment including any of the above systems, etc.

The edge computing device may execute an instruction through a program module. Generally, the program module may include a routine, a program, a target program, a component, a logic, a data structure and the like, and they execute specific tasks or implement specific abstract data types. The computer system/server may be implemented in a distributed cloud computing environment, and in the distributed cloud computing environment, tasks are executed by a remote processing device connected through a communication network. In the distributed cloud computing environments, the program modules can be located in both local or remote computer storage media including storage devices.

The edge computing device may perform data interaction with the server device, for example, the server device can send data to the edge computing device by invoking an interface of the edge computing device, and after receiving the data from the server device through a corresponding interface, the edge computing device may process the received data; and the edge computing device may also send data to the server device.

The following exemplarily describes an application scenario of the embodiments of the disclosure.

In a platform game scenario, running states of various games may be detected through a computer vision processing technology.

In the embodiments of the disclosure, computer vision is a science that studies how to make a machine “see”, which refers to detecting and measuring a target by using a camera and computer instead of human eyes, and further performing image processing. During a game, what is happening on a game platform may be detected by using three cameras so as to perform further analysis. The game platform may be a physical tabletop platform or other physical platforms.

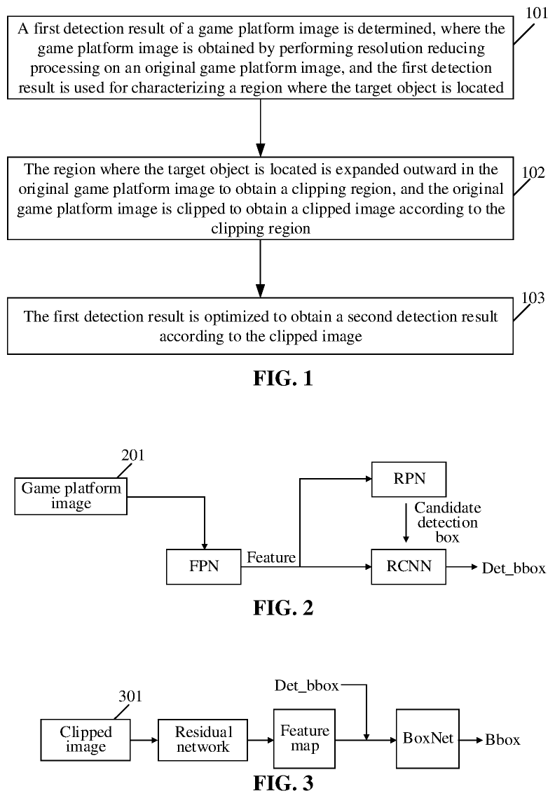

FIG. 1 is a flowchart of a target detection method of the embodiments of the disclosure. As shown in FIG. 1, the process may include the following operations.

At S101, a first detection result of a game platform image is determined, where the game platform image is obtained by performing resolution reducing processing on an original game platform image, and the first detection result is used for characterizing a region where the target object is located.

In the embodiments of the disclosure, the original game platform image may include one or more frames of image. In actual applications, video data or image data may be obtained by photographing a game platform by using at least one camera, and then at least one frame of original game platform image is acquired from the video data or the image data. In some embodiments, the camera for photographing the game platform may be a camera located right above the game platform for photographing the game platform from a top view, or may also be a camera for photographing the game platform from other angles. Correspondingly, each frame of original game platform image may be the game platform image from the top view or other view angles. In some other embodiments, each frame of original game platform image may also be an image obtained by performing fusion processing on the game platform image from the top view or other view angles.

After the original game platform image is obtained, the original game platform image may be subjected to resolution reducing process to obtain a game platform image. Then, target detection is performed on the original game platform image through the computer vision processing technology to obtain a first detection result of the game platform image.

In some embodiments, the target object may include at least one of a human body, a game item, or a fund substitute. For example, the human body in the target object may include the whole human body, and may also include part of a human body, such as a human hand and a human face; the game item may be poker cards, which may be of types of spade, heart, diamond, club.

In some embodiments, the region where the target object is located may be presented through a detection box of the target object. Illustratively, the region where the target object is located may be determined through coordinate information of the detection box of the target object.

In some embodiments, the target detection model may be trained in advance. The target detection is performed on the game platform image by using the trained target detection model to obtain the first detection result of the game platform image.

The embodiments of the disclosure do not limit the network structure of the target detection model, and the network structure of the target detection model may be a two-stage detection network structure, for example, the network structure of a vehicle detection model is a Faster-RCNN, etc.; and the network structure of the target detection model may also be a single-stage detection network structure, for example, the network structure of the target detection model is a RetinaNet, etc.

FIG. 2 is a schematic diagram of target detection on a game platform image by using the Faster-RCNN framework in the embodiments of the disclosure. Referring to FIG. 2, the Faster-RCNN framework includes a Feature Pyramid Networks (FPN), a Region Proposal Network (RPN), and a Region with Convolutional Neural Network (RCNN) as a backbone. The FPN is configured to extract features of a game platform image 201, and input the extracted features into the RPN and the RCNN. The RPN is configured to generate a candidate detection box according to the input features, and the candidate detection box may be called an anchor. The RPN may send the candidate detection box to the RCNN. The RCNN can process the input features and the candidate detection box to obtain the first detection result of the game platform image. In the embodiments of the disclosure, the first detection result of the game platform image may be denoted as Det_bbox.

At S102, the region where the target object is located is expanded outward in the original game platform image to obtain a clipping region, and the original game platform image is clipped to obtain a clipped image according to the clipping region.

In some embodiments, a detection box of the target object is expanded in at least one of an upward direction, a downward direction, a leftward direction, or a rightward direction in the original game platform image to obtain the clipping region. Illustratively, the detection box of the target object may be respectively expanded for N pixels in the upward direction, the downward direction, the leftward direction, and the rightward direction to obtain the clipping region, and N may be set according to actual requirements, for example, the value of N may be 15, 20 or 25.

It can be seen that the clipping region is greater than the region where the target object is located. In addition, the resolution of the original game platform image is greater than that of the game platform image, so the clipped image obtained by clipping the original game platform image according to the clipping region can reflect fine local information of the target object.

Here, the original game platform image is clipped, so that coordinates of each pixel point of the clipped image are changed compared to those of the original game platform image. Therefore, the coordinates of the detection box of the target object in the clipped image may be adaptively changed.

At S103, the first detection result is optimized to obtain a second detection result according to the clipped image.

It is to be understood that the second detection result is used for characterizing the region where the target object is located, and the region where the target object is located will change when the second detection result is compared with the first detection result.

In actual applications, S101 to S103 may be implemented by using the processor in the electronic device. The above processor may be at least one of an Application Specific Integrated Circuit (ASIC), a Digital Signal Processor (DSP), a Digital Signal Processing Device (DSPD), a Programmable Logic Device (PLD), a Field-Programmable Gate Array (FPGA), a Central Processing Unit (CPU), a controller, a microcontroller, or a microprocessor.

It can be seen that the clipping region is greater than the region where the target object is located, and the resolution of the original game platform image is higher than that of the game platform image, the clipped image can reflect fine local information of the target object, and then the first detection result is optimized according to the clipped image, which is beneficial to obtaining the region where the target object is located more accurately, and improves the accuracy of target detection.

In some embodiments of the disclosure, an implementation mode that the first detection result is optimized to obtain the second detection result according to the clipped image may include that: an image feature of the clipped image is extracted; a feature of the target object in the clipped image is determined according to the first detection result and the above image feature; and the second detection is obtained according to the feature of the target object.

Illustratively, the image feature of the clipped image may be extracted by using a residual network or other convolutional neural networks. In actual applications, a convolution operation may be performed on the clipped image to obtain the image feature of the clipped image by using the residual network or other convolutional neural networks.

It is to be understood that residual blocks inside the residual network use jump connection, which alleviates the vanishing gradient caused by increasing the depth in a depth neural network. Therefore, it is beneficial to increasing the accuracy of image feature extraction by extracting the image features of the clipped image by using the residual network.

Illustratively, the feature of the clipped image may be presented by a Feature Map or other modes.

Illustratively, the feature of the target object in the clipped image may be extracted at the position of the region characterized by the first detection in the clipped image in combination with the first detection result after the image feature of the clipped image and the first detection result are obtained, so that feature matching is performed in the clipped image to obtain an accurate position of the target object in the clipped image according to the feature of the target object in the clipped image, so as to determine the region of the target object in the clipped image, that is, the second detection result is determined.

It can be seen that since the clipped image can reflect fine local information of the target object, it is more beneficial to determining the region where the target object is located more accurately according to the image feature of the clipped image and the first detection result, and improves the accuracy of target detection.

In some embodiments of the disclosure, the operation that the feature of the target object in the clipped image is determined according to the first detection result and the image feature of the clipped image may include that: the first detection result and the image feature of the clipped image are input into a regression model, and the first detection result and the image feature of the clipped image are processed by using the regression model to obtain the feature of the target object in the clipped image.

Correspondingly, the operation that the second detection result is obtained according to the feature of the target object may include that: the feature of the target object is processed to obtain the second detection result by using the regression model.

Here, the regression model is used for performing regression prediction on the region where the target object is located in the clipped image, and the principle of the regression prediction is that: each factor that affects a prediction target is found out by taking a correlation principle of prediction as a basis, and then the approximate expression of functional relationships between these factors and the prediction target are found out.

In some embodiments of the disclosure, the second detection result may be regarded as the prediction target of the regression prediction, and the first detection result and the image feature of the clipped image may be regarded as independent variables that affect the prediction target.

Illustratively, the above regression model may be a fully connected network. The fully connected network may be one layer or two layers of fully connected networks. It is to be understood that the first detection result and the image feature of the clipped image may be integrated to acquire a high-level semantic feature of the image by using the fully connected network, so as to implement the regression prediction accurately.

It can be seen that the first detection result and the image feature of the clipped image may be processed by using the regression model in the embodiments of the disclosure, which is beneficial to obtaining the second detection result accurately.

Referring to FIG. 3, a clipped image 301 may be input into the residual network, and the clipped image 301 is processed by using the residual network, so as to obtain a feature map characterizing the image feature of the clipped image 301. Then, a first detection result Det_bbox of the game platform image and the feature map are input into a two-layer fully connected network BoxNet, and the regression prediction is performed on the first detection result Det_bbox of the game platform image and the feature map to obtain the second detection result by using the two-layer fully connected network BoxNet. In the embodiments of the disclosure, Bbox represents the second detection result.

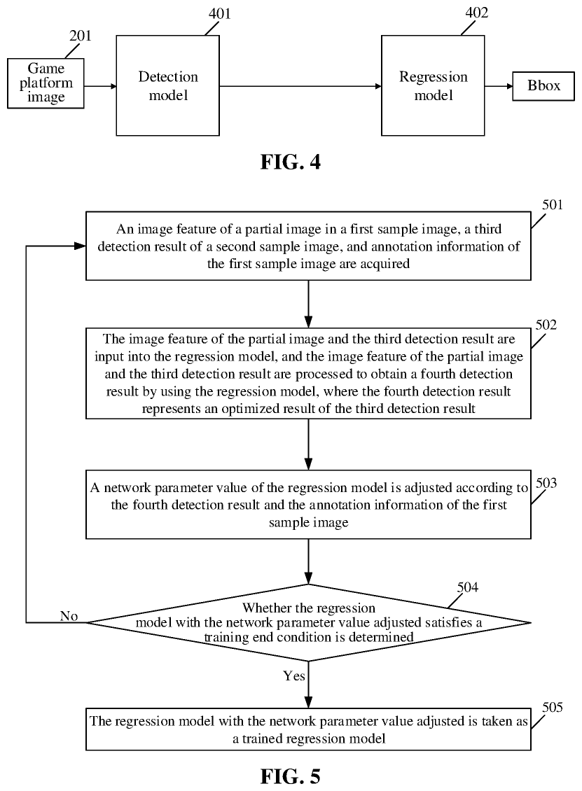

Referring to FIG. 4, the embodiments of the disclosure may be implemented on the basis of a network in which a detection model 401 and a regression model 402 are connected in cascade. The detection model 401 is configured to detect the game platform image 201 to obtain a first detection result. The regression model 402 is configured to optimize the first detection result to obtain a second detection result Bbox according to fine local information of the target object in an original game platform image with fine definition, so that the region where the target object is located characterized by the second detection result Bbox is more accurate, that is, a position boundary of the target object may be determined more accurately.

A training process of the above regression model is illustratively described below through accompanying drawings.

FIG. 5 is a flowchart of a training method for a regression model of the embodiments of the disclosure. As shown in FIG. 5, the process may include the following operations.

At S501, an image feature of a partial image in a first sample image, a third detection result of a second sample image, and annotation information of the first sample image are acquired.

Here, the second sample image is obtained by performing resolution reducing processing on the first sample image. The third detection result is used for characterizing a region where a reference object is located. The region of the partial image includes the region where the reference object is located.

In some embodiments, the reference object may include at least one of a human body, a game item, or a fund substitute. For example, the human body in the reference object may include the whole human body, and may also include part of the human body, such as a human hand and a human face; the game item may be poker cards, which may be of types of spade, heart, diamond, club.

In some embodiments, the first sample image represents an image including the reference object. The first sample image may be acquired from a public data set, or the first sample image may also be collected through an image collection apparatus.

In some embodiments, the second sample image may be input into the above detection model, and the second sample image is processed by using the detection model to obtain the third detection result.

In some embodiments, the third detection result may be reflected by a detection box of the reference object, so that the detection box of the reference object may be expanded in at least one of an upward direction, a downward direction, a leftward direction, or a rightward direction in the first sample image to obtain an expanded region; and then, the first game platform image is clipped to obtain a partial image in the first sample image according to the expanded region.

After the partial image of the first sample image is obtained, the image feature of the partial image in the first sample image may be extracted by using the residual network or other convolutional neural networks.

In the embodiments of the disclosure, the first sample image may be acquired, the region where the reference object is located in the first sample image may be annotated to obtain annotation information of the first sample image. Here, the annotation information of the first sample image represents: a real value of the region where the reference object is located in the first sample image.

At S502, the image feature of the partial image and the third detection result are input into the regression model, and the image features of the partial images and the third detection result are processed by using the regression model to obtain a fourth detection result. The fourth detection result represents an optimized result of the third detection result.

At S503, a network parameter value of the regression model is adjusted according to the fourth detection result and the annotation information of the first sample image.

In the embodiments of the disclosure, the loss of the regression model may be determined according to the fourth detection result and the annotation information of the first sample image, and then the network parameter value of the regression model is adjusted according to the loss of the regression model.

At S504, whether the regression model with the network parameter value adjusted satisfies a training end condition is determined; if not, S501 to S504 are re-executed; if so, S505 is executed.

In the embodiments of the disclosure, the training end condition may be that the number of iterations when the regression model is trained reaches a set number, or the loss of the regression model with the network parameter value adjusted is less than a set loss. Here, the set number and the set loss may be set in advance.

At S505, the regression model with the network parameter value adjusted is taken as a trained regression model.

In actual applications, S501 to S505 may be implemented by using a processor in an electronic device. The above processor may be at least one of the ASIC, the DSP, the DSPD, the PLD, the FPGA, the CPU, the controller, the microcontroller, or the microprocessor.

It can be seen that, in the embodiments of the disclosure, by training the regression model in advance, the position of the target object in an image can be detected accurately by using the trained regression model.

The embodiments of the disclosure are illustratively described below in combination with an application scenario. In the application scenario, the original game platform image may be acquired first, and resolution reducing processing is performed on the original game platform image to obtain a game platform image with low resolution. Then, the game platform image is detected on the basis of the Faster-RCNN framework, so as to obtain a first detection result of the game platform image. The first detection result may be an initial detection box of a game item. The game item represents an item configured to make a game work normally.

After an initial detection box of the game item is obtained, an initial detection box may be expanded outwards in the original game platform image to obtain a clipping region. The original game platform image is clipped according to the clipping region to obtain a clipped image. Then, an image feature of the clipped image is extracted. The image feature of the clipped image and the initial detection box of the game item are input into the regression model, and the image feature of the clipped image and the initial detection box of the game item are processed by using the regression model to obtain a final detection box of the game item.

It is to be understood that, in the embodiments of the disclosure, the final detection box of the game item is a result obtained by optimizing the initial detection box of the game item in combination with the original game platform image, while the original game platform image can reflect fine local information of the game item, so compared with the initial detection box of the game item, the final detection box of the game item can reflect the position information of the game item more accurately. Further, on the basis of the detection model, the embodiments of the disclosure can improve the accuracy of the postilion of the game item by adding the regression model, that is, the position information of the game item can be predicted more accurately on the basis of adding a small amount of calculation.

It can be understood by those skilled in the art that, in the above-mentioned method of the specific implementation modes, the writing sequence of each step does not mean a strict execution sequence and is not intended to form any limitation to the implementation process and a specific execution sequence of each step should be determined by functions and probable internal logic thereof.

The embodiments of the disclosure provide a target detection apparatus on the basis of the target detection method provided by the foregoing embodiments.

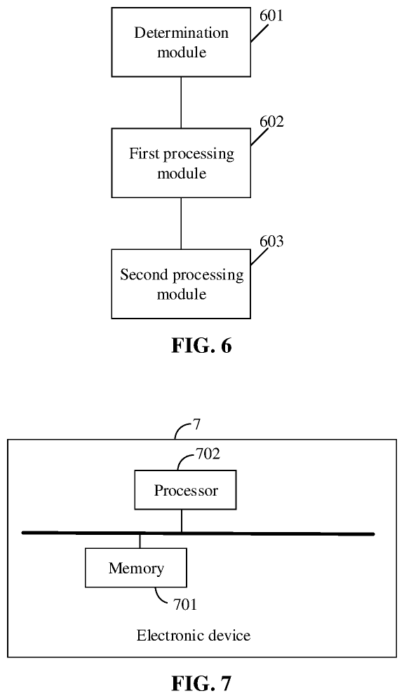

FIG. 6 is a schematic diagram of a composition structure of a target detection apparatus of the embodiments of the disclosure. As shown in FIG. 6, the apparatus may include: a determination module 601, a first processing module 602, and a second processing module 603.

The determination module 601 is configured to determine a first detection result of a game platform image, where the game platform image is obtained by performing resolution reducing processing on an original game platform image, and the first detection result may be used for characterizing a region where the target object is located.

The first processing module 602 is configured to expand the region where the target object is located outward in the original game platform image to obtain a clipping region, and clip the original game platform image to obtain a clipped image according to the clipping region.

The second processing module 603 is configured to optimize the first detection result to obtain a second detection result according to the clipped image.

In some embodiments, the second processing module 603 is specifically configured to perform the following operations.

An image feature of the clipped image is extracted.

A feature of the target object in the clipped image is determined according to the first detection result and the image feature.

The second detection result is obtained according to the feature of the target object.

In some embodiments, the second processing module 603 is specifically configured to extract an image feature of the clipped image by using a residual network.

In some embodiments, the second processing module 603 is specifically configured to: input the first detection result and the image feature into a regression model, and process the first detection result and the image feature by using the regression model to obtain the feature of the target object in the clipped image; and process the feature of the target object by using the regression model to obtain a second detection result.

In some embodiments, the regression model is a fully connected network.

In some embodiments, the apparatus further includes a training module. The training module is specifically configured to train the regression model by using the following steps.

An image feature of a partial image in a first sample image, a third detection result of a second sample image, and annotation information of the first sample image are acquired. The second sample image is obtained by performing resolution reducing processing on the first sample image. The third detection result is used for characterizing a region where a reference object is located. The region of the partial image includes the region where the reference object is located.

The image feature of the partial image and the third detection result are input into the regression model. The image feature of the partial image and the third detection result are processed to obtain a fourth detection result by using the regression model. The fourth detection result represents an optimized result of the third detection result.

A network parameter value of the regression model is adjusted according to the fourth detection result and the annotation information of the first sample image.

In some embodiments, the region where the target object is located is a detection box.

The first processing module 602 is specifically configured to expand the detection box in at least one of an upward direction, a downward direction, a leftward direction, or a rightward direction in the original game platform image to obtain the clipping region.

In actual applications, all of the determination module 601, the first processing module 602, and second processing module 603 may be implemented by using the processor in the edge computing device. The above processor may be at least one of the ASIC, the DSP, the DSPD, the PLD, the FPGA, the CPU, the controller, the microcontroller, or the microprocessor.

In addition, various functional modules in the embodiments may be integrated into one processing unit, or each of the units may exist alone physically, or two or more units are integrated into one unit. The integrated unit may be implemented in a form of hardware, or may be implemented in a form of a software functional module.

When the integrated unit is implemented in the form of software function module and is not sold or used as an independent product, it can be stored in a computer readable storage medium. Based on such an understanding, all or some of the embodiments may be implemented in a form of a software product. The software product is stored in a storage medium and includes several instructions for instructing a computer device (which may be a personal computer, a server, a network device, or the like) or a processor (processor) perform all or some of the steps of the methods described in the embodiments. The foregoing storage medium includes: any medium that can store program code, such as a USB flash drive, a removable hard disk, a read-only memory (Read Only Memory, ROM), a random access memory (Random Access Memory, RAM), a magnetic disk, or an optical disc.

Specifically, a computer program instruction corresponding to a target detection method in the embodiment may be stored on storage media, such as a compact disc, a hard disc, and a USB flash disc. When the computer program instruction corresponding to the target detection method in the storage medium is read or executed by an electronic device, any target detection method in the foregoing embodiments is implemented.

Based on the same technical concept of the foregoing embodiments, the embodiments of the disclosure further provide an electronic device. Referring to FIG. 7, an electronic device 7 provided by the embodiments of the disclosure may include: a memory 701 and a processor 702.

The memory 701 is configured to store computer programs and data.

The processor 702 is configured to execute the computer programs stored in the memory, so as to implement any target detection method of the foregoing embodiments.

In practical application, the above-mentioned memory 701 may be a volatile memory, for example, a Random-Access Memory (RAM), or a non-volatile memory, for example, a Read-Only Memory (ROM), a flash memory, a Hard Disc Driver (HDD), or a Solid-State Drive (SSD), or a combination of the above-mentioned types of memories, and provides an instruction and data for the processor 702.

The above processor 702 may be at least one of the ASIC, the DSP, the DSPD, the PLD, the FPGA, the CPU, the controller, the microcontroller, and the microprocessor. It can be understood that other electronic devices may also be configured to realize functions of the processor for different devices, which is not specifically limited in the embodiments of the disclosure.

In some embodiments, the functions or modules of the apparatus provided by the embodiments of the disclosure can be used to execute the method described in the above method embodiments, and its specific implementation may refer to the description of the above method embodiment. For simplicity, it will not be elaborated herein.

The above description of various embodiments tends to emphasize the differences among various embodiments, and their same points or similarities can be referred to each other. For simplicity, it will not be elaborated here.

The methods disclosed in various method embodiments provided in the disclosure may be freely combined without conflicts to obtain new method embodiments.

The characteristics disclosed in various product embodiments provided in the disclosure may be freely combined without conflicts to obtain new product embodiments.

The characteristics disclosed in various method or device embodiments provided in the disclosure may be freely combined without conflicts to obtain new method embodiments or device embodiments.

According to the description of the foregoing implementations, a person skilled in the art can clearly understand that the method in the foregoing embodiments may be implemented by software in addition to a necessary universal hardware platform or by hardware only. In most cases, the former is an exemplary implementation. Based on such an understanding, all or part of the embodiments of this disclosure may be embodied in a form of a software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods the embodiments of this disclosure.

The embodiments of the disclosure are described above with reference to the accompanying drawings, but the disclosure is not limited to the embodiments. The embodiments are only illustrative rather than restrictive. Inspired by the disclosure, a person of ordinary skill in the art can still derive a plurality of variations without departing from the essence of the disclosure and the protection scope of the claims. All these variations shall fall within the protection of the disclosure.

What is claimed is:

1. A target detection method, comprising:
determining a first detection result of a game platform image, wherein the game platform image is obtained by performing resolution reducing processing on an original game platform image, and the first detection result is used for characterizing a region where a target object is located;
expanding the region where the target object is located outward in the original game platform image to obtain a clipping region, and clipping the original game platform image to obtain a clipped image according to the clipping region; and
optimizing the first detection result to obtain a second detection result according to the clipped image.

2. The method of claim 1, wherein the optimizing the first detection result to obtain a second detection result according to the clipped image comprises:
extracting an image feature of the clipped image;
determining a feature of the target object in the clipped image according to the first detection result and the image feature; and
obtaining the second detection result according to the feature of the target object.

3. The method of claim 2, wherein the extracting an image feature of the clipped image comprises:
extracting the image feature of the clipped image by using a residual network.

4. The method of claim 2, wherein the determining a feature of the target object in the clipped image according to the first detection result and the image feature comprises:
inputting the first detection result and the image feature into a regression model, and processing the first detection result and the image feature by using the regression model to obtain the feature of the target object in the clipped image;
wherein the obtaining the second detection result according to the feature of the target object comprises:
processing the feature of the target object to obtain the second detection result by using the regression model.

5. The method of claim 4, wherein the regression model is a fully connected network.

6. The method of claim 4, wherein a training method of the regression model comprises following steps:
acquiring an image feature of a partial image in a first sample image, a third detection result of a second sample image, and annotation information of the first sample image, wherein the second sample image is obtained by performing resolution reducing processing on the first sample image, the third detection result is used for characterizing a region where a reference object is located, and a region of the partial image comprises the region where the reference object is located;
inputting the image feature of the partial image and the third detection result into the regression model, and processing the image feature of the partial image and the third detection result by using the regression model to obtain a fourth detection result, wherein the fourth detection result represents an optimized result of the third detection result; and
adjusting a network parameter value of the regression model according to the fourth detection result and the annotation information of the first sample image.

7. The method of claim 1, wherein the region where the target object is located is a detection box;
wherein the expanding the region where the target object is located outward in the original game platform image to obtain a clipping region comprises:
expanding the detection box in at least one of an upward direction, a downward direction, a leftward direction, or a rightward direction in the original game platform image to obtain the clipping region.

8. An electronic device, comprising a processor and a memory configured to store a computer program capable of running on the processor,
wherein when executing the computer program stored in the memory, the processor is configured to:
determine a first detection result of a game platform image, wherein the game platform image is obtained by performing resolution reducing processing on an original game platform image, and the first detection result is used for characterizing a region where a target object is located;
expand the region where the target object is located outward in the original game platform image to obtain a clipping region, and clip the original game platform image to obtain a clipped image according to the clipping region; and
optimize the first detection result to obtain a second detection result according to the clipped image.

9. The electronic device of claim 8, wherein the processor is specifically configured to:
extract an image feature of the clipped image;
determine a feature of the target object in the clipped image according to the first detection result and the image feature; and
obtain the second detection result according to the feature of the target object.

10. The electronic device of claim 9, wherein the processor is specifically configured to:
extract the image feature of the clipped image by using a residual network.

11. The electronic device of claim 9, wherein the processor is specifically configured to:
input the first detection result and the image feature into a regression model, and process the first detection result and the image feature by using the regression model to obtain the feature of the target object in the clipped image;
wherein the processor is specifically configured to:
process the feature of the target object to obtain the second detection result by using the regression model.

12. The electronic device of claim 11, wherein the regression model is a fully connected network.

13. The electronic device of claim 11, wherein a training method of the regression model comprises following steps:
acquiring an image feature of a partial image in a first sample image, a third detection result of a second sample image, and annotation information of the first sample image, wherein the second sample image is obtained by performing resolution reducing processing on the first sample image, the third detection result is used for characterizing a region where a reference object is located, and a region of the partial image comprises the region where the reference object is located;
inputting the image feature of the partial image and the third detection result into the regression model, and processing the image feature of the partial image and the third detection result by using the regression model to obtain a fourth detection result, wherein the fourth detection result represents an optimized result of the third detection result; and
adjusting a network parameter value of the regression model according to the fourth detection result and the annotation information of the first sample image.

14. The electronic device of claim 8, wherein the region where the target object is located is a detection box;
wherein the processor is specifically configured to:
expand the detection box in at least one of an upward direction, a downward direction, a leftward direction, or a rightward direction in the original game platform image to obtain the clipping region.

15. A non-volatile computer-readable storage medium, having a computer program stored thereon, wherein when executed by a processor, the computer program is configured to:
determine a first detection result of a game platform image, wherein the game platform image is obtained by performing resolution reducing processing on an original game platform image, and the first detection result is used for characterizing a region where a target object is located;
expand the region where the target object is located outward in the original game platform image to obtain a clipping region, and clip the original game platform image to obtain a clipped image according to the clipping region; and
optimize the first detection result to obtain a second detection result according to the clipped image.

16. The non-volatile computer-readable storage medium of claim 15, wherein the computer program is specifically configured to:
extract an image feature of the clipped image;
determine a feature of the target object in the clipped image according to the first detection result and the image feature; and
obtain the second detection result according to the feature of the target object.

17. The non-volatile computer-readable storage medium of claim 16, wherein the computer program is specifically configured to:
extract the image feature of the clipped image by using a residual network.

18. The non-volatile computer-readable storage medium of claim 16, wherein the computer program is specifically configured to:
input the first detection result and the image feature into a regression model, and process the first detection result and the image feature by using the regression model to obtain the feature of the target object in the clipped image;
wherein the computer program is specifically configured to:
process the feature of the target object to obtain the second detection result by using the regression model.

19. The non-volatile computer-readable storage medium of claim 18, wherein the regression model is a fully connected network.

20. The non-volatile computer-readable storage medium of claim 18, wherein a training method of the regression model comprises following steps:
acquiring an image feature of a partial image in a first sample image, a third detection result of a second sample image, and annotation information of the first sample image, wherein the second sample image is obtained by performing resolution reducing processing on the first sample image, the third detection result is used for characterizing a region where a reference object is located, and a region of the partial image comprises the region where the reference object is located;
inputting the image feature of the partial image and the third detection result into the regression model, and processing the image feature of the partial image and the third detection result by using the regression model to obtain a fourth detection result, wherein the fourth detection result represents an optimized result of the third detection result; and
adjusting a network parameter value of the regression model according to the fourth detection result and the annotation information of the first sample image.
